(19) United States
(12) Patent Application Publication
(10) Pub. No.: US 2026/0249637 A1
(43) Pub. Date: Aug. 27, 2026

(54) GREETING CARD WITH DECKLED EDGES AND METHODS OF MANUFACTURE

(71) Applicant: MICHAEL JOHN ABRAHAM, HOUSTON, TX (US)

(72) Inventor: MICHAEL JOHN ABRAHAM, HOUSTON, TX (US)

(21) Appl. No.: 19/395,310

(22) Filed: Nov. 20, 2025

Related U.S. Application Data
(63) Continuation-in-part of application No. 29/992,421, filed on Mar. 7, 2025.
(60) Provisional application No. 63/762,462, filed on Feb. 24, 2025.

(51) Int. Cl. B42D 15/04

(52) U.S. Cl. CPC B42D 15/045

(57) ABSTRACT

A multipurpose greeting card article that can be used as a standalone gift of artwork which can be displayed as an upright, two panel item on a flat surface such as a fireplace mantel, or as a single panel wall hanging is disclosed. The greeting card saves having to shop separately for both a gift, and a card. It includes a rear panel brace to support its front panel, portions of which can be comprised of deckled edges for an enhanced artistic appeal, and with no gusseted bottom panel needed to stand upright or tented for enhanced display. The panels can be comprised of heavy weight artist's paper or other sturdy material, which can be decorated. Further, a perforated deckling guideline can be applied to ensure accuracy of the placement of the deckling so as not to tear into an art or decoration area.

### CROSS REFERENCE TO RELATED APPLICATIONS:

This application claims the benefit of an earlier filing date and right of priority to U.S. Provisional Application No. 63/762,462, filed 24 Feb. 2025, and is a Continuation-In-Part of U.S. Design application Pat. No. 29,992,421, filed 7 Mar. 2025, the contents of which is incorporated by reference herein in its entirety.

### BACKGROUND OF THE INVENTION

### 1. Field of the Invention

The present application relates to an improved form and method of manufacturing for greeting cards, and more particularly to producing greeting cards to serve as both frameable art pieces and free-standing decorations.

### 2. Description of Related Art

Gift-giving and accompanying written sentiments have been longstanding traditions across human civilization. Traditional greeting cards emerged in the 19th century as a means of conveying written sentiments alongside gifts, with the first commercial greeting cards appearing in Europe around 1843. The greeting card industry subsequently evolved to incorporate various printing technologies and design elements, becoming a significant mass-produced market by the early 20th century.

Concurrently, the practice of displaying art in homes through framing has been a common method of interior decoration and personal expression. Traditional greeting cards as seen in FIGS. 1 and 2 of the drawings, while often featuring artistic elements, are typically designed for temporary display if any, and are generally disposed of after their ceremonial purpose is fulfilled. This in turn creates an incentive for minimal archival effort, as only rarely are purchased cards kept for any length of time.

In FIGS. 1-2, the two obverse sides (inside face and outside face) of a standard two-panel prior art greeting card are shown. Generally, card 99 is flat during the printing and/or decorating process and subsequently folded along fold line 97 to form an outside face having a front side 94a and a back side 94b (FIG. 1); and an inside face having a left side 96a and a right side 96b (FIG. 2). When folded, front side 94a of the outside face becomes the front cover of the card, while the back side 94b becomes the back cover. The card recipient then unfolds card 99 along the fold line 97 to show the left side 96 a of the inside as the first panel, and the right side 96 b of the inside as the second panel.

Current solutions in the market fail to bridge the gap between temporary greeting cards and permanent displayable art. While some greeting cards may be retained for sentimental value, they are not typically designed with consideration for long-term display or framing. Conversely, while framed art pieces may be given as gifts, they lack the personal sentiment traditionally conveyed through greeting cards.

Although strides have been made, shortcomings remain.

### BRIEF SUMMARY OF THE INVENTION

It is an object of the present application to provide a dual-purpose article that functions both as a greeting card and as frameable art. The article incorporates specialized manufacturing techniques that allow for both traditional card edges and decorative perforations and/or tears used to selectively create a deckled edge. This solution enables gift-givers to combine the sentimental value of a greeting card with the lasting impact of displayable art, while providing recipients with the option to preserve the artistic element of the card through conventional framing methods.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a view of an outside face of a conventional greeting card.

FIG. 2 is a view of an inside face of the conventional greeting card of FIG. 1.

FIGS. 3-4 show a printed card member according to an embodiment of the present application.

FIGS. 5-6 show the card member of FIGS. 3-4 being deckled without a guideline path.

FIG. 7 is an embroidery machine used to produce perforations on the card member of FIGS. 3-4.

FIG. 8 is the card member of FIGS. 5-6 with perforations made from the machine of FIG. 7.

FIGS. 9-10 are views of the card member of FIG. 8 with guideline paths to illustrate the path for creating a deckled edge.

FIGS. 11-13 are views of an optional guideline path for use with the card member of FIG. 8.

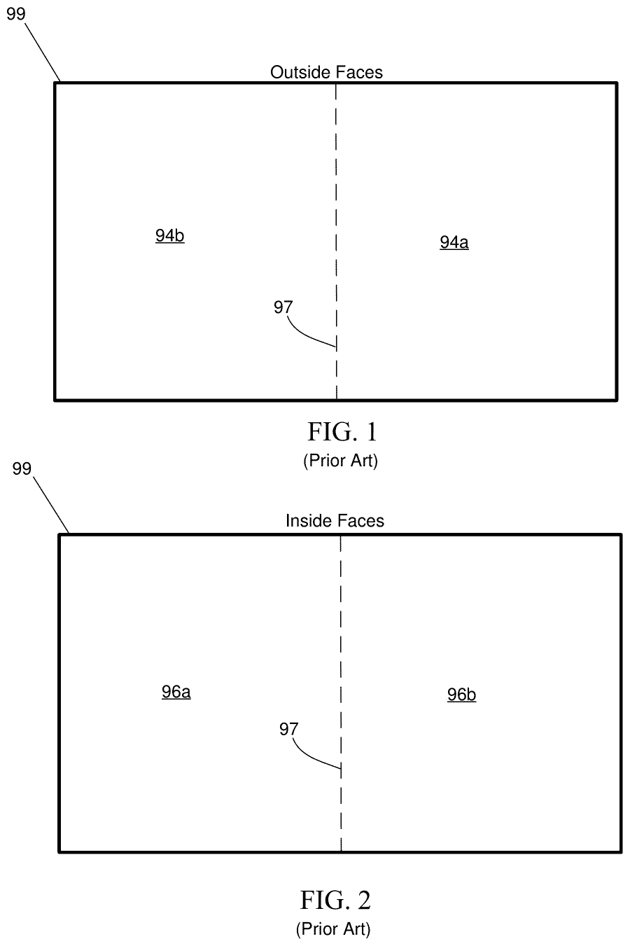

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

It is noted that the embodiments and method in accordance with the present application overcomes one or more of the above-discussed problems commonly associated with the prior art discussed previously. In particular, the assembly and method of the present application is configured to provide a card member having a plurality of faces and corresponding sides that are used to provide graphical indicia and/or messages. Edging of the card member may be formed to include guidelines that act as perforations or guides to tearing of the card member so as to create a deckled edging. A user may selectively tear along any of the guidelines to create a desired deckled edge.

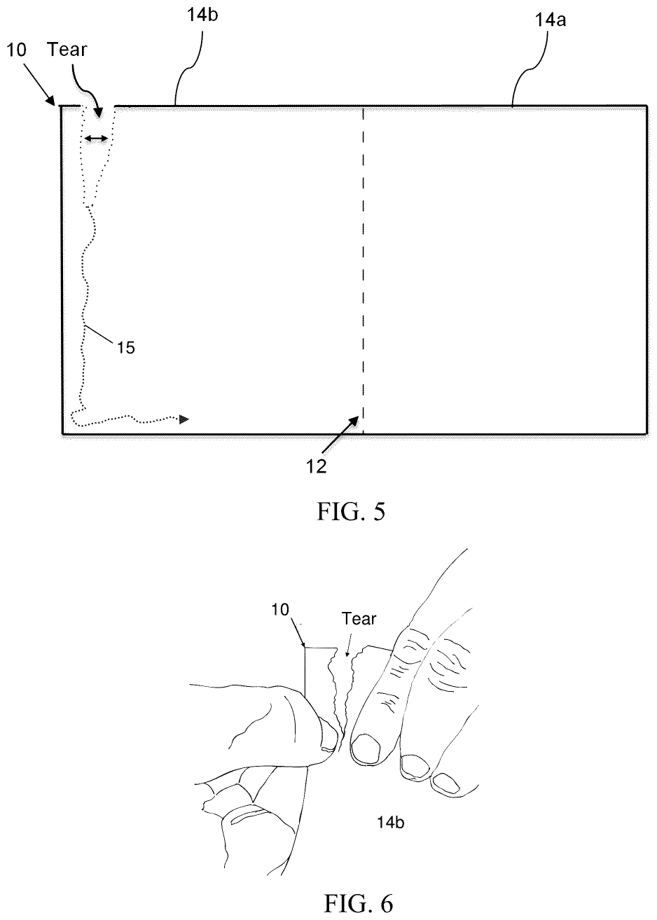

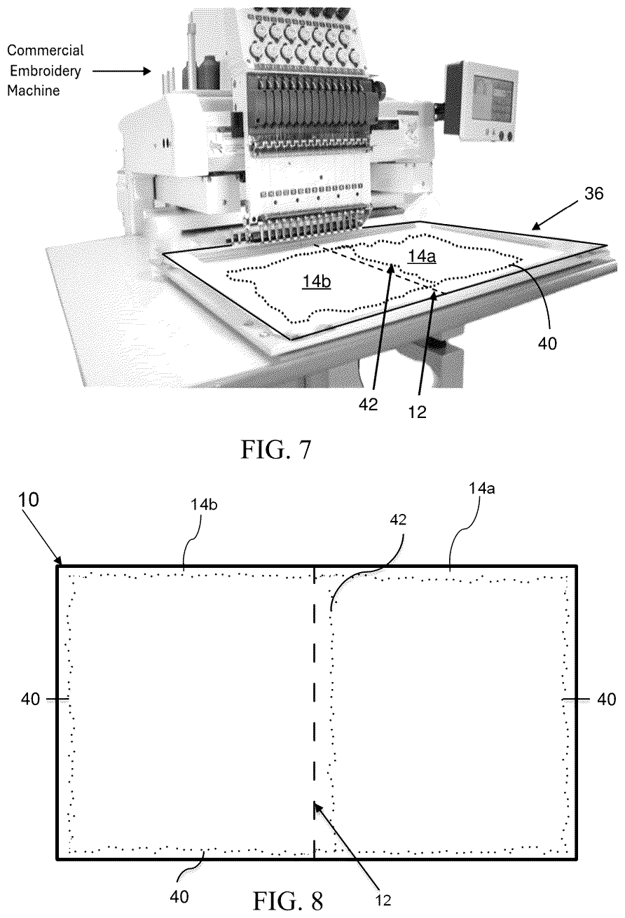

The method of the present application will be shown as providing the steps and process of a user creating a deckled edging from a card member both with and without incorporated guidelines. FIGS. 5-6 will relate to the card member and method without guidelines and FIGS. 7-13 will refer to the card member and method with guidelines. It is understood that the method or process illustrated in either of these embodiments may be used with the other embodiment. These and other unique features are discussed below and illustrated in the accompanying drawings.

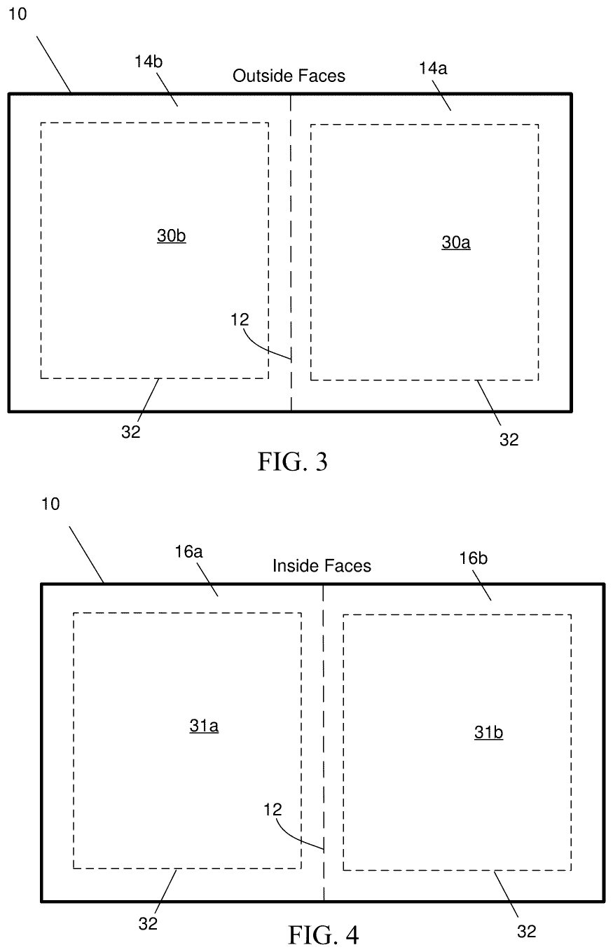

Referring now to FIGS. 3-4 in the drawings, a card member is illustrated. Card member 10 is similar in form and function to that of card 99 in that it includes inside and outside faces, each with two sides therein configured to be folded and receive graphical indicia through printing or writing. Card member 10 is illustrated in both FIGS. 3 and 4 of the drawings. Within FIG. 3 of the drawings, outside faces 14a and 14b are shown. Card member 10 includes a fold line 12 that acts to differentiate faces 14a and 14b. Card member 10 is configured to fold along fold line 12 such that the outside faces 14a and 14b form a front cover (14a) and a back cover (14b). Likewise, inside faces 16a and 16b of card number 10 are illustrated within FIG. 4 of the drawings. When folded along fold line 12, inside faces 16a and 16b create a left and right side, respectively. The left side is distinguished as being inside face 16a while the right side is distinguished as being inside face 16b.

Both the inside faces and the outside faces may include graphical indicia areas 30a, 30b, 31a, 31b which are configured to include decorations or print in the form of letters, artwork, or any textual information. Card member 10 further includes margins 32 which are illustrated on both the inside faces and the outside faces. Margin 32 is representative of the defined areas within each face that may include graphical indicia areas. Each graphical indicia area 30a, 30b, 31a, 31b is shown defined by margins 32. The application method of the graphical indicia may vary depending on the type of material used for card member 10. The placement of the graphical indicia can be centered on the card member or offset depending on the final look desired.

Margins 32 provides a general defined area of the printing layout to accept graphical indicia. Although not required, it is understood that at least one of graphical indicia areas 30a, 30b, 31a, 31b may be decorated or printed with artwork or text. A space exists between margins 32 and the outer edges of card member 10 as well as fold line 12. This allows for some of the material of card member 10 to be selectively removed later during a manual or automated deckling process, as described subsequently.

As shown later in FIGS. 7-10, an optional deckle guideline path 40 can be printed or formed onto the card outside of margins 32 to indicate a path for manual tearing. This guideline path 40 may be fully visual (i.e., a printed or stenciled line) or may be perforated.

Referring now to FIGS. 5-6 in the drawings, a process of hand deckling the edges of card number 10 is illustrated. Card member 10 is illustrated without showing graphical indicia areas for clarity purposes. In the alternative, it is optionally possible to deckle the paper prior to applying the artwork and/or imprinting. The outside faces 14a and 14b are provided to illustrate a hand deckling process of a user. In this process, the user does not have guideline path 40 as illustrated in the later embodiment. The implied guideline path 15 is a representative dashed line that illustrates the potential route a user may tear along the edges to create the deckled edge. The deckling happens outside of margin 32. In FIG. 5, the tearing process has begun around the edges of outside face 14b.

It is understood that fold line 12 is not always aligned with the center of card member 10. Fold line 12 may be shifted to the right or left so as to leave room for the substrate removed via hand deckling. When the tearing process is completed, fold line 12 may roughly define a new “center” of the material of card member 10, which may be offset any amount from the physical center of card member 10. Even subsequent to deckling, the fold line 12 may be off center for aesthetic reasons.

The substrate material of card member 10 is torn by hand so that the separated edges become deckled with a rough, feathered, and irregular appearance. The goal is to achieve an amorphous, jagged, uneven edge, so exact measurements are not necessary, so long as the deckling follows the implied deckle guideline path 15 between the margin 32 and the edge of card member 10.

The process of tearing the card member may be done in different ways. One such way is hereby illustrated. The card member paper is held down to a surface with one thumb while slightly rolling the paper edge with the other hand, pulling it apart to allow the paper to tear naturally. A flat surface can alternately be used as an edge to tear against. The paper is torn in a controlled manner letting the paper break unevenly. The paper fibers separate unevenly, creating a rough, uneven edge.

Referring now also to FIGS. 7-10 in the drawings, illustrating an embroidery machine 17 used to create deckle guideline path 40. FIG. 7 shows a commercial embroidery machine with a work surface bounded by hoop 36, which utilizes a sawing action to sew, thereby perforating the paper. In a method embodiment, the flat, undeckled, open (unfolded) card 10 is placed containing the graphical indicia imagery face up (in this case located on outside faces 14a, 14b), within an embroidery hoop 36 locked in place and traced on the embroidery machine to embroider a border around the graphical indicia. Alternatively, it may be used to create a border in which to apply a graphical indicia. The border should be placed between the outer edge of the paper and the outline of the imprinted graphical indicia area, again leaving enough space to allow for a deckled guideline path 40 to be sewn, and hand-deckling to be performed. It is placed to avoid interfering with the graphical indicia or the embroidered border. The linear fold line 12 is depicted with dashed lines, while the irregular deckle perforations 40 are depicted with dotted lines. Additionally, this embodiment features an inner deckle guideline path 42 generally amorphous to linear fold line 12.

The deckle guideline path 40 is defined by perforations, which may be achieved using a thread-less handheld perforation tool (e.g., a needle, a rotary perforation tool or powered awl). Alternately, a sewing machine may be used with or without thread, to define the deckled guideline path, or a commercial embroidery machine with or without thread may be used with the path's design digitized along with the digitization of the margin 32, and to sew a deckle guideline applied using a single line straight stitch, or other stitch type as desired, with the distance between each stitch close enough to perforate a guideline allowing an easier tear by softening the paper where the hand deckle will be performed.

Efficiency is improved since the perforated deckle guideline 40 path can be sewn while the paper is still hooped in relation to the margin while still on the machine. The digitized path's design enables the machine to perforate, puncture, and/or indent the paper as required, creating the deckling path and softening the paper such that the deckling is made easier along its path and during the tearing process. Further, it guides a hand tear along the paper to prevent errors of tearing through margin 32, or the graphical indicia itself.

Standard embroidery backing may be applied against the paper as desired to stabilize the paper during embroidery. It understood that other substrates are also possible, for example stiffened cloth, clothes in general, and plastics to name a few. Randomization of the guideline deckle path can be done during design digitization where the path can be customized as desired. Each deckle path and design can be different for uniqueness, or repeated. Today, commercial embroidery machines can increment designs like automating the sewing of individual names onto jerseys. The deckled path 40 can be delineated by a sewing thread, which provides both a visual and tactile indicator of the deckling path. This sewing thread is removed during the subsequent hand deckling process.

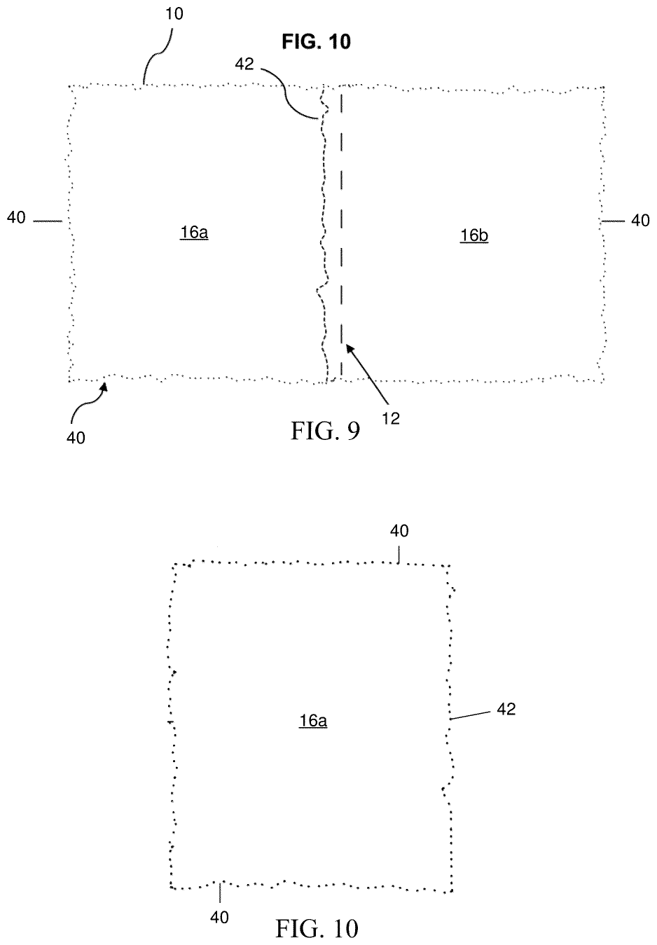

The deckle guideline path 40 is extended along the inner portion 42 of the panel, between the margin 32 and/or the fold line 12 of the card 10. In an embodiment, this portion of the guideline path 40 can be invisible while the remainder of the guideline path 40 inner portion 42 is visible to preserve the visual option of an “outer” deckle tear while. In another embodiment, this path 42 of the guideline path 40 is visible, perforated, and/or threaded. A user may selectively tear card member 10 along guideline path 40 as seen in FIG. 9. Optionally, a user may further deckle card member 10 by tearing along inner guideline path 42 so as to isolate the card to only one side, as seen in FIG. 10. It is worth noting that card member 10 is reversed so as to show inside faces 16a and 16b in FIGS. 9-10.

Various display configurations for the fully printed and deckled card 10 are possible. It is understood that card 10 as illustrated in FIG. 9 may be displayed in various different orientations. For example, card member 10 may be displayed upright wherein the card is slightly opened when folded upon fold line 12. Likewise card member 10 may be rotated into a horizontal orientation wherein the card member 10 opens to a surface and fold line 12 is elevated and horizontal.

Furthermore, card member 10 may also be framed. A deckled edge may be formed around guideline path 40. The card member 10 may be folded in either direction along fold line 12 so as to present graphical indicia for display. The deckled edging of card member 10 acts to present a unique and aesthetically pleasing edging. It is understood that card member 10 may be oriented vertically or horizontally within a frame. Within another display embodiment, card member 10, as illustrated in FIG. 10 of the drawings, may also be framed for display.

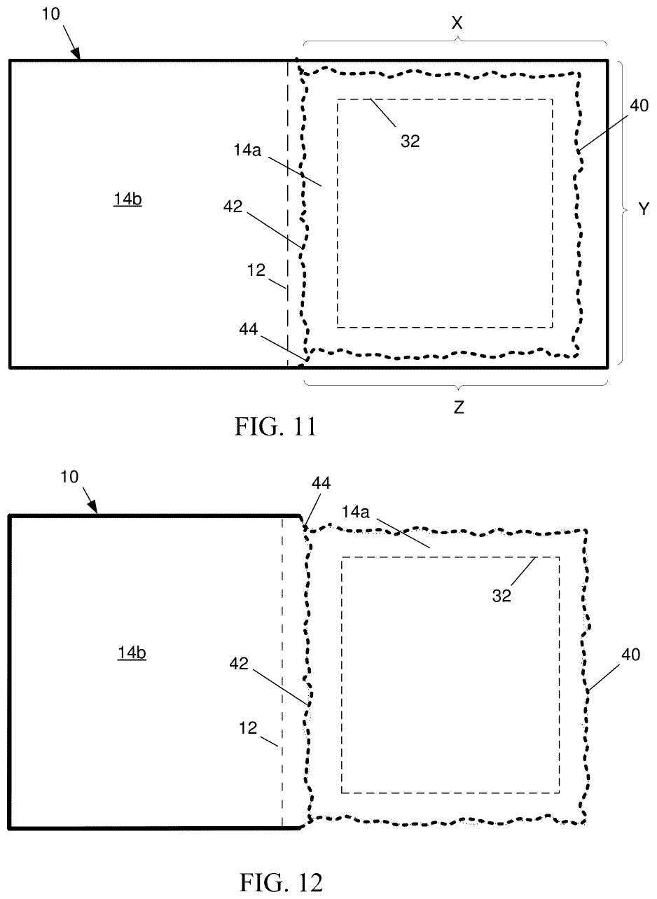

Referring now also to FIGS. 11-13 in the drawings, views of an optional guideline path for use with card member 10 are illustrated. The card member of FIG. 8 included guideline path 40 which ran around the edges of card number 10 between the edge and the margin 32. Card member 10 of FIG. 8 also included a vertical inner deckle guideline path 42 that ran adjacent to fold line 12. Card member 10, as illustrated in FIGS. 11-13, is further modified such that guideline path 40 is restricted to an individual face or side of card member 10. It is understood that guideline path 40 may be routed or ran through any portions or faces of card member 10. As seen in FIGS. 11-13, guideline path 40 is restricted to outside face 14a and/or inside face 16a. As illustrated, graphical indicia is located within margins 32 on outside face 14a.

Guideline path 40 includes a guideline path extension 44 extending from inner deckle guideline path 42 to the edges of card number 10. Extension 44 is similar in form and function to that of guideline path 40 and inner decal guideline path 42. The path of extension 44 is such that it is configured to extend from the interchange of guideline path 40 and inner deckled guideline path 42. Although not required, it is desirable that extension 44 reach the edge of card member 10 without crossing fold line 12. In so doing, the path of guideline path extension 44 is restricted to the same side and/or face of card member 10 as that of paths 40 and 42. It is understood that extension 44 is not herein limited to the interchange of paths 40 and 42 but may in fact be at any location along paths 40 or 42.

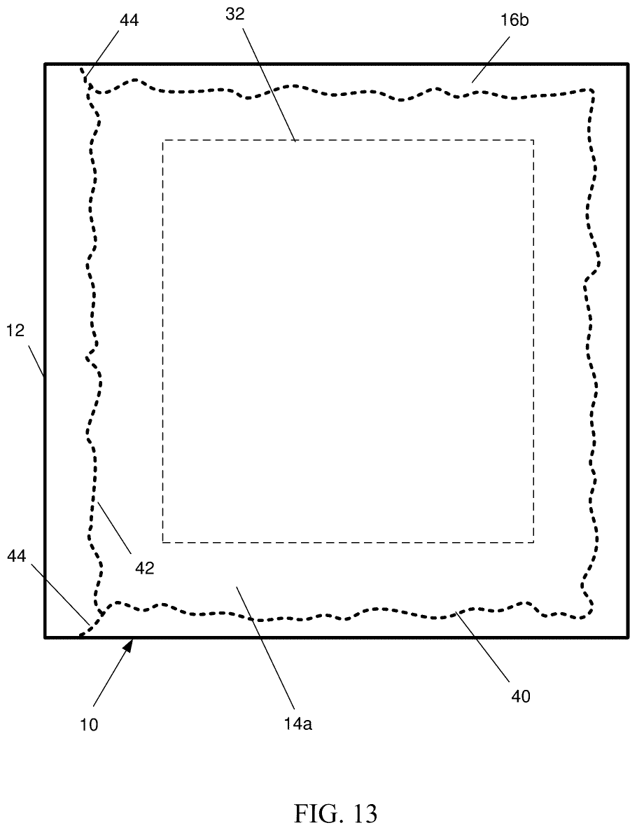

The inclusion of path extension 44 is partly to aid a user in beginning the tearing process of card number 10. By starting at a specific edge, the user is able to tear into its face so as to reach paths 40 and 42. As seen in particular with FIG. 11 of the drawings, borders X, Y, and Z are the removable edges of inside face 14a as defined by guideline path 40. FIG. 12 illustrates card member 10 wherein borders X, Y, and Z are removed.

Similar to card member 10 as seen in FIGS. 7-10, Card number 10 of FIGS. 11 through 13 are also suitable for display either within or without a frame. The same orientations and rotations are possible as seen previously. FIG. 13 of the drawings illustrates card number 10 wherein it is oriented vertically such that card member 10 is closed. The removal of borders X, Y, and Z now exposes inside face 16b. The card member may be slightly opened along fold line 12 to rest vertically in one orientation. Likewise, card member 10 may be rotated horizontally such that it opens at the surface it is resting upon. Furthermore, card member 10 can be framed with its backing of face 16B showing as seen in FIG. 13, or wherein inside space 14a is detached along guide path 42 to provide a fully deckled edge. It is understood that other methods of display utilizing pins or adhesives may be used and those described herein are not meant to be limiting. A key feature of the present assembly and method is the unique ability to display artistically the imagery and graphical indicia of cards received.

It is understood that the different embodiments illustrated herein illustrate the same card member sequentially receiving additional optional features. For example, card number 10 as illustrated in FIGS. 3 and 4 did not have guide paths 40 and 42. A deckled edge would be manually added by a user by tearing around the edges of card member 10. This process was illustrated in FIGS. 5-6. Optionally, a perforation or guideline path could be added to card number 10 to help a user identify a desired deckled pattern. FIGS. 8-10 show the inclusions of guide paths 40 and 42 which permitted the user the option to deckle the entire edging of card member 10 and/or selectively isolate particular graphical indicia along a singular face of card member 10. Likewise, card number 10 in FIGS. 11 through 13 restrict guideline paths 40 and 42 to that to being within a particular phase. Inner guideline path extensions 44 are included to extend from paths 40 and 42 to the edge of its particular face. The same display options exist for any of these card members.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A deckled card, comprising:
a card member having a plurality of faces;
a graphical indicia area located on the card member on at least one of the plurality of faces; and
a guideline path formed between the graphical indicia and an edge of the card member.

2. The card of claim 1, wherein the guideline path is a perforation of the card member.

3. The card of claim 1, wherein the guideline path extends around a perimeter of the entire card member.

4. The card of claim 3, further comprising:
a guideline path extension extending from the guideline path and the edge of the card member.

5. The card of claim 1, wherein the guideline path is restricted to a singular face.

6. The card of claim 1, further comprising:
an inner guideline path extending within the guideline path on a singular face of the plurality of faces.

7. The card of claim 6, wherein a guideline path extension extending from at least one of the guideline path and the inner guideline path and the edge of the card member.

8. The card of claim 1, wherein the graphical indicia is removable from the card member.

9. A method of creating a deckled edge on a greeting card, comprising:
obtaining a card member, the card member having:
an edge around its perimeter;
a fold line extending between the edge so as to define a plurality of faces on the card member; and
a graphical indicia area located on at least one of the plurality of faces; and
tearing the card member between the edge and the graphical indicia area to create the deckled edge.

10. The method of claim 9, further comprising:
adding a guideline path around the perimeter of the card member between the edge and the graphical indicia.

11. The method of claim 10, wherein the guideline path extends around the entire perimeter of the card member.

12. The method of claim 11, further comprising:
adding an inner guideline path within and between the guideline path as the guideline path extends around the perimeter, the inner guideline path being parallel to the fold line.

13. The method of claim 10, wherein the guideline path extends around a portion of the perimeter of the card member within a singular face of the plurality of faces.

14. The method of claim 13, further comprising:
adding an inner guideline path within and between the guideline path as the guideline path extends around the perimeter.

15. The method of claim 13, further comprising:
forming a guideline path extension extending from the guideline path and the edge of the card member to form removable borders to create the deckled edge.

16. The method of claim 10, wherein tearing of the card member along the guideline path creates a deckled edge.

17. The method of claim 9, wherein tearing of the card member creates a deckled edge around the perimeter of the card member.

18. The method of claim 9, further comprising:
displaying the card member to show the graphical indicia area.

19. The method of claim 9, wherein tearing of the card member creates a deckled edge around a face of the plurality of faces.

20. The method of claim 19, further comprising:
displaying the card member to show the graphical indicia area of the singular face in front of a secondary face of the plurality of faces, the secondary face being larger than and visible behind the deckled edge of the singular face.
